(19) United States
(12) Patent Application Publication
(10) Pub. No.: US 2006/0161343 A1
(43) Pub. Date: Jul. 20, 2006

(54) Mobile navigation

(76) Inventors: Hugh John Agnew, Hampshire (GB); Daniel William Ormsby, Hampshire (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/516,606

(22) PCT Filed: Jun. 16, 2003
(86) PCT No.: PCT/GB03/02576

§ 371 Date: Jan. 27, 2006

(30) Foreign Application Priority Data
Jun. 14, 2002 (GB) 02137297

(51) Int. Cl. G01C 21/34

(52) U.S. Cl. 701/211; 701/202; 340/995.19

(57) ABSTRACT

A navigation guidance system is provided which gives direction information to a user via their mobile telephone. In one embodiment, the user pre-arranges their trip using a web-based route calculation server. The web-based server prompts the user to provide their mobile telephone number so that updated navigation instructions can be provided to the user as they are travelling towards their destination. In a preferred embodiment, the mobile telephone number and the user's travel plans are transmitted to a second navigation server which transmits a text message to the user's mobile telephone prompting them to call a given number to receive updated navigation instructions to arrive at their chosen destination.

The present invention relates to a system and method for providing navigation assistance to a user for guiding the user to a desired destination. The invention is particularly, although not exclusively relevant to a system for providing navigation instructions or traffic related information to a user via a mobile unit, such as a telephone, personal digital assistant etc.

Various systems have been proposed for providing mobile users with route guidance information for guiding a user from a source location to a desired destination. The applicants have proposed in their earlier International application WO 01/88480 a system in which a user makes a telephone call, via a GPS-enabled mobile telephone, to a remote navigation control centre. The navigation control centre interrogates the phone to determine the GPS position of the phone, from which it determines the user's current location. The navigation control centre also prompts the user to identify their desired destination. The navigation control centre then uses the current GPS position and the desired destination to calculate route guidance instructions which it transmits back to the user via the mobile telephone link.

One aim of the present invention is to provide an alternative mobile navigation system.

Other aspects of the present invention will become apparent from the following detailed description of preferred embodiments which are described with reference to the following drawings in which:

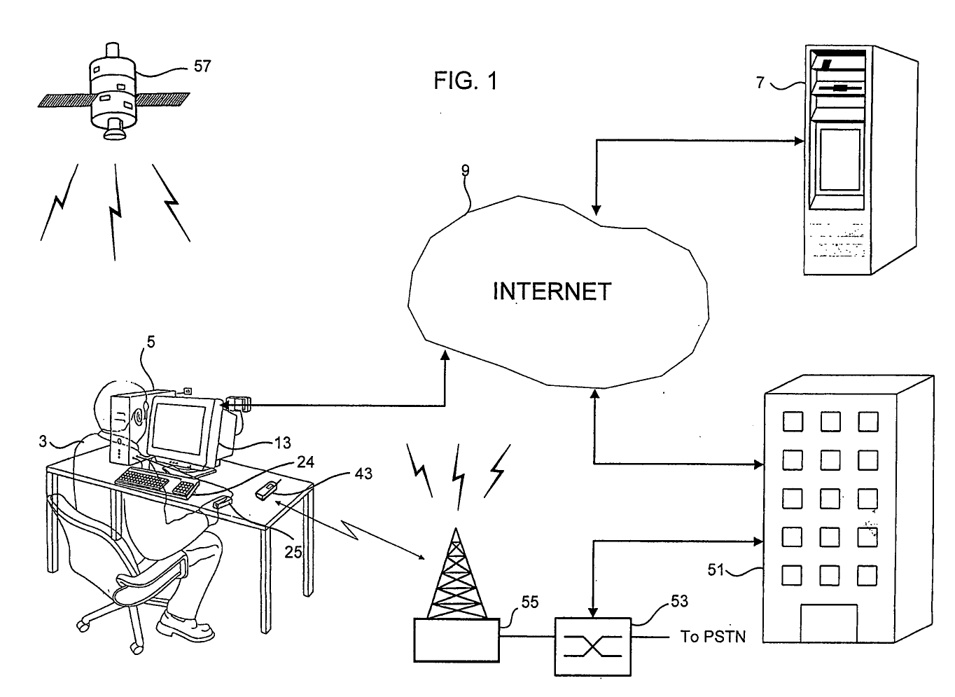

FIG. 1 is a schematic diagram illustrating a navigation system embodying the present invention;

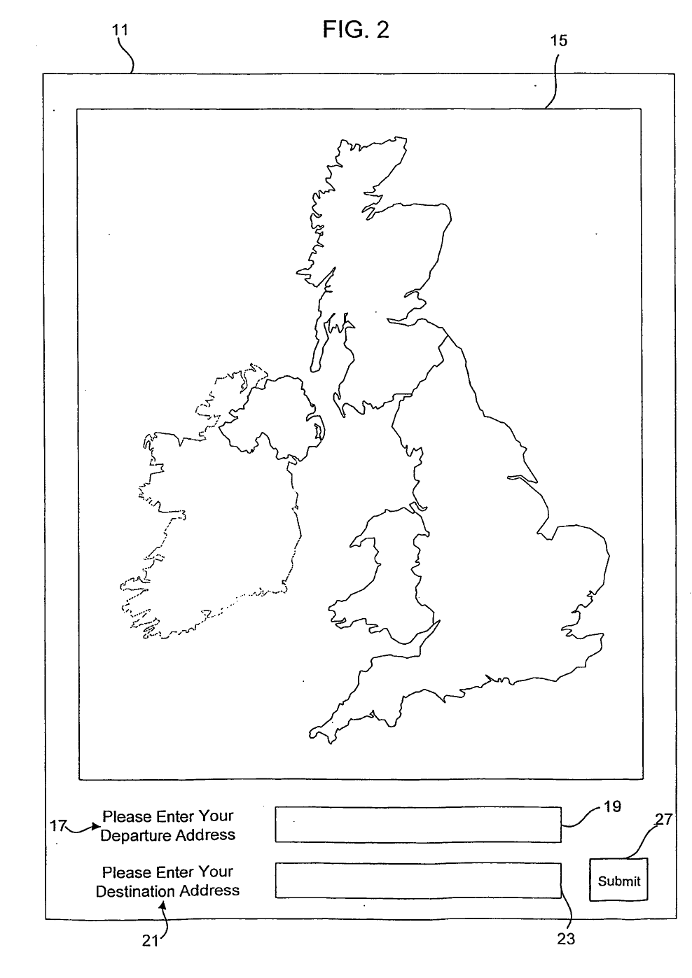

FIG. 2 illustrates a web page downloaded to a user terminal from a remote web-based navigation server forming part of the navigation system shown in FIG. 1 and prompting the user to enter a departure address and a destination address;

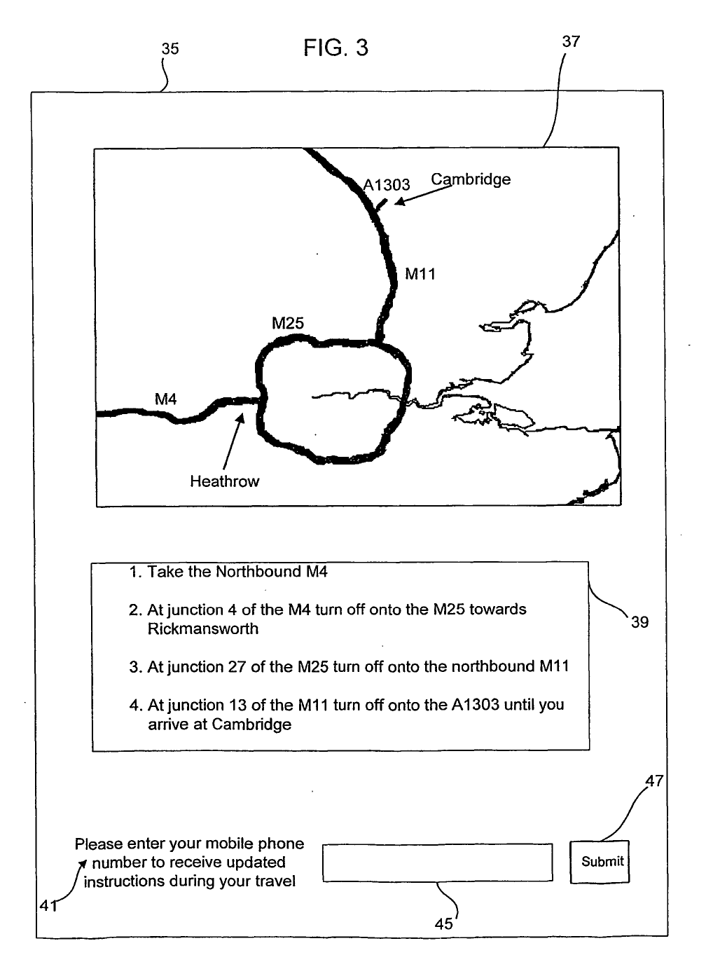

FIG. 3 illustrates a web page generated by the remote web-based navigation server shown in FIG. 1 in response to a query for navigation instructions from London Heathrow Airport in the UK to Cambridge in the UK;

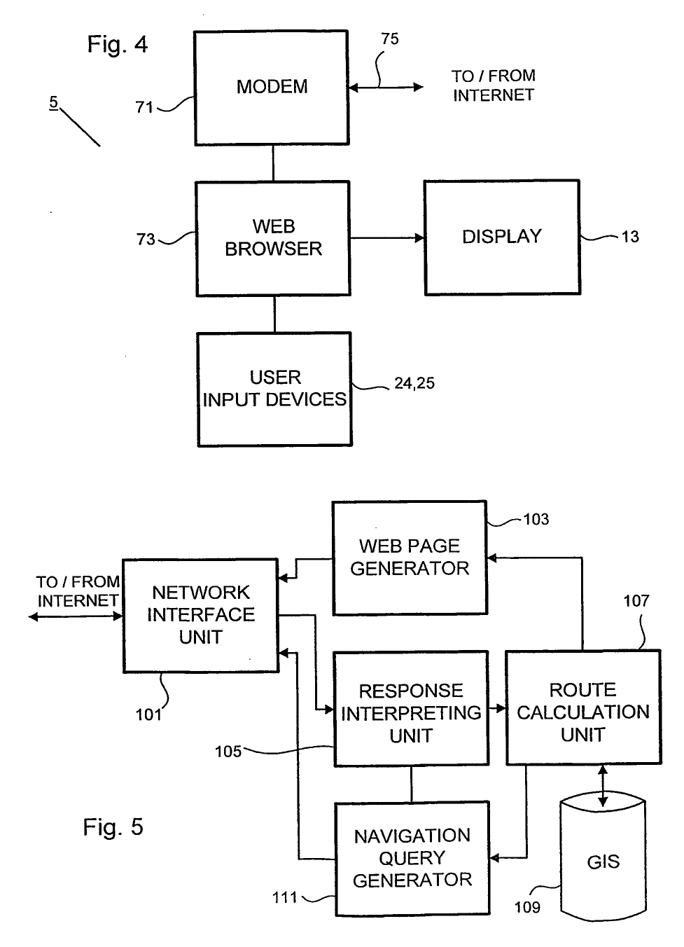

FIG. 4 is a block diagram illustrating the main functional components of a user terminal forming part of the navigation system shown in FIG. 1;

FIG. 5 is a block diagram illustrating the main functional components of the web-based navigation server shown in FIG. 1;

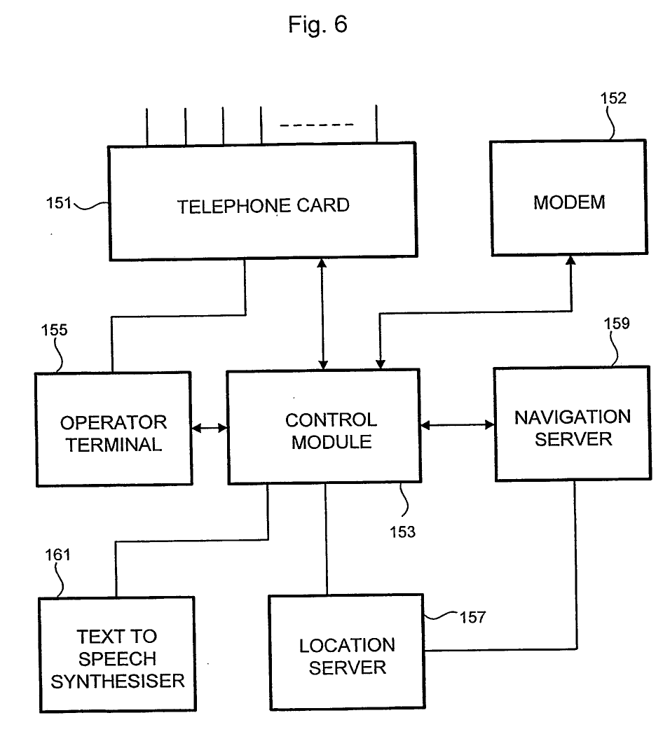

FIG. 6 is a block diagram illustrating the main functional components of a telephone-based navigation control centre forming part of the navigation system shown in FIG. 1; and

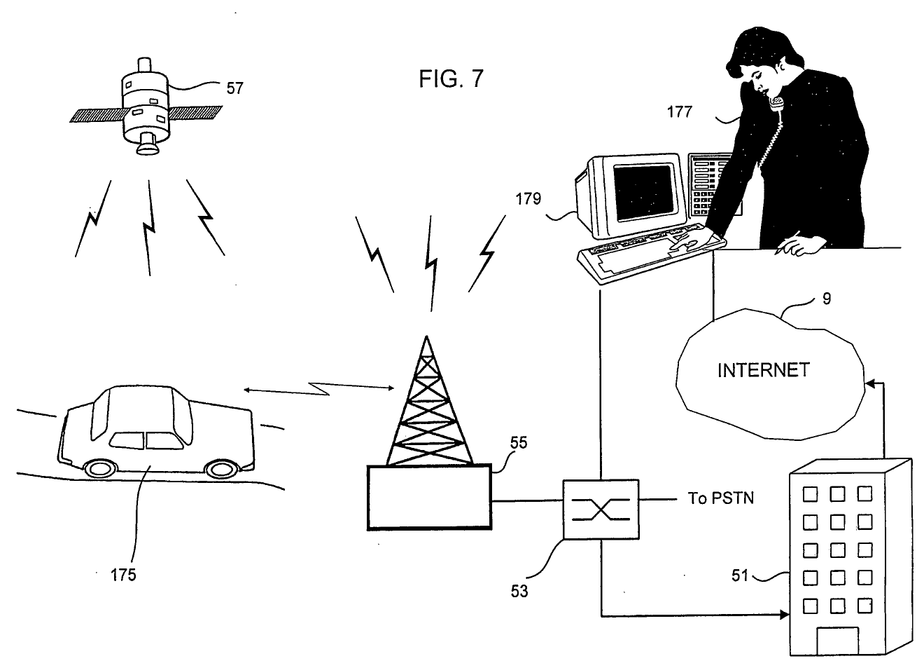

FIG. 7 is a schematic diagram illustrating a navigation system according to an alternative embodiment of the present invention.

### FIRST EMBODIMENT

Overview

FIG. 1 is a schematic diagram illustrating the main components of an internet-based and mobile telephone-based navigation system, which is generally referenced by reference numeral 1. In operation, a user 3 uses a personal computer 5 or the like to connect to a remote internet (or web) based navigation server 7 via the internet 9. The web-based navigation server 7 operates to prompt the user 3 to input a departure address and a destination address. In this embodiment, the web-based navigation server 7 does this by downloading a web page 11 (shown in FIG. 2) to the user's personal computer 5 for display on the display 13 thereof. As shown in FIG. 2, in this embodiment, the web page 11 includes a graphic window 15 in which a map of the user's country (in this case the UK) is displayed. Underneath the graphic box 15, the web page 11 includes a prompt 17 for the user to enter the departure address in the text box 19 and a prompt 21 for the user to enter the destination address in the text box 23. After the user has typed in the appropriate addresses using the keyboard 24, the user can transmit the departure and destination address information back to the remote web-based navigation server 7 by using, for example, a mouse 25 forming part of the personal computer 5 to move and click a cursor on a submit box 27.

Upon receiving the user's departure address and destination address, the web-based navigation server 7 uses an internal database (not shown) of road network data to calculate an appropriate route from the user's departure address to the destination address. The web-based navigation server 7 then downloads the calculated navigation instructions in a web page back to the user's personal computer 5 for display on the display 13. FIG. 3 illustrates the form of the navigation results web page 35 generated when the user's departure address is London Heathrow Airport (in the UK) and the destination address is Cambridge (in the UK). As shown in FIG. 3, the navigation results web page 35 includes a graphic box 37 in which a visual overview of the route to be taken is displayed; and a text box 39 in which text instructions are provided for navigating from the departure address to arrive at the destination address. Further, as shown in FIG. 3, the navigation results web page 35 also includes a prompt 41 for the user to enter the telephone number for their mobile telephone 43, if they wish to receive updated navigation instructions whilst they are travelling from the departure address to the destination address. If the user does wish to receive such updated instructions, the user enters the telephone number for their mobile telephone 43 in the text box 45 and then uses the mouse 25 to move and click the cursor on the submit button 47, which causes the mobile number to be transmitted back to the web-based navigation server 7 via the internet 9.

In this embodiment, if the web-based navigation server 7 receives the user's mobile telephone number, then it generates a navigation query which identifies the user's departure address, destination address, mobile telephone number and details of the route already calculated for the user (e.g. road network link data identifying the road segments and junctions to be traversed to follow the calculated route). The web-based navigation server 7 then transmits this navigation query over the internet 9 to a mobile telephone-based navigation control centre 51, which operates to keep track of the user as they progress from the departure address to the destination address and to provide them, when appropriate, with updated navigation instructions. Updated navigation instructions may be required if the user deviates from the originally calculated route or if traffic congestion results in an alternative route being quicker than the originally calculated route.

In this embodiment, when the mobile phone-based navigation control centre 51 receives the navigation query from the web-based navigation server 7, it extracts the user's mobile telephone number and the destination address and automatically generates a text message which it transmits (via the telephone exchange 53 and the base station 55) to the user's mobile telephone 43 using the short messaging service (SMS) or the like. In this embodiment, the text message informs the user that updated traffic information for their required destination can be obtained by telephoning a given telephone number. For example, the text message transmitted by the mobile telephone-based navigation control centre 51 may take the form:
“For updated traffic navigation information to find Cambrige, dial 0123 456-789”.

The text message has therefore been personalised for the user by including their destination address.

When the user sets off en route to their required destination, the user may call the mobile phone-based navigation control centre 51 (using the telephone number provided in the received text message) using their mobile telephone 43 to check for updated navigation instructions prior to setting off en route. In this embodiment, the user's mobile telephone 43 includes a GPS receiver (not shown) which receives GPS signals from overhead satellites 57 from which the GPS receiver can determine the current longitude and latitude of the user. In this embodiment, when the user establishes a call to the telephone number for the mobile telephone navigation control centre 51, the control centre 51 uses caller line identification (CLI) to determine which user is making the call and retrieves the current navigation plan stored for that user. At the same time, the control centre 51 interrogates the GPS receiver in the user's mobile telephone 43 to determine the user's current longitude and latitude. The control centre 51 then passes this information to a human operator (not shown) who can speak with the user and to query with the user if their web-based navigation query is still valid and, if it is, to provide them with updated navigation instructions based on their previously entered destination and their current GPS position. In this embodiment, the updated route guidance instructions are transmitted to the user either as text instructions or as synthesised speech instructions which are generated from the text instructions.

The above description has provided an overview of a web and mobile telephone-based navigation system embodying the present invention. A more detailed description will now be given of some of the components of the system.

User Personal Computer

FIG. 4 is a block diagram illustrating the main functional components of the user's personal computer 5 shown in FIG. 1. As shown, the personal computer 5 includes a modem 71 which connects a web browser 73 to the internet 9 via a telephone line 75. As those skilled in the art will appreciate, the web browser 73 is a conventional software program which can run on the personal computer's central processing unit (not shown). The web browser 73 is responsible for receiving the web pages downloaded from the web-based navigation server 7 and for generating the appropriate display frame for output to the display 13. The web browser 73 is also responsive to the user's input from the user input devices, i.e. the keyboard 24 and the mouse 25. In particular, in this embodiment, the web browser 73 is responsible for receiving the typed input of the user's departure and destination addresses and the user's mobile telephone number and to submit these to the web-based navigation server 7 when the user clicks the appropriate submit button using the mouse 25. The web browser 73 also receives the initial route guidance information from the web-based navigation server 7 which it displays to the user on the display 13. If required, these instructions can also be printed out via a connected printer (not shown).

Web-Based Navigation Server

FIG. 5 is a block diagram illustrating the main components of the web-based navigation server 7 shown in FIG. 1. As shown, the navigation server 7 includes a network interface 101 which connects the navigation server 7 to the internet 9. The navigation server 7 also includes a web page generator 103 which generates the web pages which are downloaded to the user's personal computer 5 over the internet 9. Initially, when the user logs on to the web-based navigation server 7, the web page generator 103 generates and downloads the initial web page shown in FIG. 2 to the user PC 5. When the user types in the appropriate departure and destination addresses and then transmits these back to the web-based navigation server 7, the received information is passed to a response interpreting unit 105. In this embodiment, the response interpreting unit 105 extracts the user's selected departure address and destination address from the received data and passes them to a route calculation unit 107 which calculates appropriate route guidance instructions from these addresses and data stored in a geographical information server (GIS) 109. In this embodiment, the data stored in the geographic information server 109 includes road network data and traffic data identifying current levels of traffic and expected levels of traffic within the road network. In this embodiment, the route calculation unit 107 calculates the quickest route from the departure address to the destination address, unless the user specifies otherwise in their query. The user may, for example, specify that they wish the shortest route or the route which avoids certain types of roads. As shown in FIG. 5, the route calculated by the route calculation unit 107 is then passed to the web page generator 103 which processes the calculated route and transforms it from a series of road link data and junction data into a format that is more readily understandable by a human (e.g. text driving instructions and/or a graphic representation of the route to be taken). The web page generator then generates the appropriate results web page such as that shown in FIG. 3, which it then downloads to the user's personal computer 5 via the network interface unit 101 and the internet 9.

If the response interpreting unit 105 receives the telephone number of a user, then it passes the user telephone number to a navigation query generator 111 which generates a navigation query for transmission to the mobile phone-based navigation control centre 51. When the response interpreting unit 105 receives the user's telephone number, it also instructs the route calculation unit 107 to pass the calculated route for that user to the navigation query generator 111. In response, the navigation query generator 111 formats a query for transmission to the mobile telephone-based navigation control centre 51. As discussed above, this query identifies the telephone number of the user, the user's departure and destination addresses and the route that was calculated by the route calculation unit 107.

Mobile Telephone-Based Navigation Control Centre

FIG. 6 is a block diagram illustrating the main components of the mobile telephone-based navigation control centre 51 shown in FIG. 1. As shown, the control centre 51 includes a telephone card 151 which provides the physical interface between the mobile telephone-based navigation control centre 51 and the telephone exchange 53. A separate modem interface 152 is provided for connecting the control centre 51 to the internet 9. The mobile telephone-based control centre 51 also includes a control module 153 which is connected to the telephone card 151 and which performs the necessary control operations for the mobile telephone-based navigation control centre 51. In operation, the control module 153 operates to receive the navigation queries from the web-based navigation server 7 via the internet 9 and modem 152. The control module 153 then extracts the user's telephone number and the destination address to generate the above-described text message which it transmits automatically to the user's mobile telephone 43. The control module 153 also passes the received navigation query to an operator terminal 155 (including a telephone handset together with a keyboard, mouse and display (not shown)) via which a human operator (not shown) can speak with the user of the mobile telephone 3 via the telephone card 151 and the telephone network. Subsequently, if the user calls the number included in the text message, then they will be routed through the telephone network and the telephone card 151 to the operator terminal 155, where the human operator can retrieve the already calculated navigation instructions and can query the user if the current destination is still the intended destination for their route. After this dialogue or during this dialogue, the control module 153 interrogates the user's mobile telephone 43 to determine the current GPS position of the user. Subsequently, after the dialogue between the operator and the user has finished, the operator confirms to the control module 153 the destination (which may be a new destination) and the control module 153 then passes the destination together with the user's current GPS position and the originally calculated route to a location server 157. The location server 157 then uses this data to access stored geographical data (not shown) to determine a route to that destination from the user's current GPS position. This determined route is then passed to a navigation server 159 which is used to generate appropriate navigation instructions for navigating the user towards their required destination.

In this embodiment, the instructions generated by the navigation server 159 are in text format which are passed to the control module 153 where they are either transmitted to the user as text or are converted into speech using a text-to-speech synthesiser 161. In order that the navigation server 159 can track the user's current position, the control module 153 requests position updates from the user's mobile telephone 43 and informs the navigation server 159 accordingly. In particular, in this embodiment, the control module 153 controls the transmission of requests for position updates which the control module 153 passes to the navigation server 159 when they are received. The navigation server 159 then uses these position updates to track the user along the calculated route and to output appropriate navigation instructions at appropriate times (such as when the user approaches a junction). Further, if the user deviates from the planned route, this can be detected by the navigation server 159 which generates further instructions to either return the user to the desired route or to determine a new route from their current location. Additionally, in this embodiment, the control module 113 can also pass navigation instructions to the operator terminal 155 so that the human operator can provide the navigation instructions directly to the user if the user prefers speaking to a human operator.

### SECOND EMBODIMENT

In the first embodiment described above, the user made initial travel plans using a web-based navigation server. These travel plans were then passed to a mobile telephone-based navigation control centre which could track the user as they progressed along their route and which could provide the user with updated navigation information. FIG. 7 schematically illustrates a further navigation system which embodies the present invention. In this embodiment, the user is already travelling in their car 175 and wishes to receive instructions to arrive at the destination (such as the office premises of a customer). As is conventional in circumstances such as this, the user uses their mobile telephone 43 to place a call via the mobile telephone base station 55 and the telephone exchange 53 to the receptionist 177 of the customer's premises to which the user is travelling. Normally in these circumstances, the receptionist 177 would provide the directions to the user over the telephone. However, this is time consuming for the receptionist 177 and depends on the local knowledge and descriptive powers of the receptionist 177. Instead, therefore, in this embodiment, the receptionist 177 asks the user to give them the user's mobile telephone number. The receptionist 177 then enters the user's telephone number into the reception computer 179 and then initiates a program which automatically generates a navigation query identifying the user's mobile telephone number and the destination (i.e. the company's address). This navigation query is then transmitted from the receptionist computer 179 over the internet 9 to the mobile telephone-based navigation control centre 51. Again, in this embodiment, upon receipt of such a query, the navigation control centre 51 transmits a text message to the user telling the user to dial a given number to receive directions to find his desired destination. Subsequently, when the user does call the number, the user is connected to an operator within the navigation control centre 51 who can confirm the destination and provide the user with the appropriate route guidance information.

### Modifications and Alternatives

Two embodiments of a mobile telephone-based navigation system have been described above. As those skilled in the art will appreciate, various modifications can be made to the embodiments described above. Some of these modifications will now be described for illustration.

In the above embodiments, the user's mobile telephone included a GPS receiver which was used to provide the mobile telephone-based navigation control centre with details of the user's current geographical position. As those skilled in the art will appreciate, this is not essential. The user may provide this geographical position information by voice. For example, identifying the road on which they are currently travelling and the nearest Junction.

In the above embodiments, the driving instructions that were generated were sent to the user either as text messages or as voice messages. As an alternative or in addition, the navigation control centre may transmit a “thumbnail” sketch or map of the route to be taken. This may be transmitted either as a bit map or as a series of vectors representing the route to be traversed.

In the above embodiment, the mobile navigation control centre determined a set of user understandable instructions which were transmitted to the user when appropriate. In an alternative embodiment, the driving instructions may be downloaded at once to the user's mobile telephone which could then track the user's progress along the calculated route and issue the driving instructions as appropriate.

In the first embodiment described above, the user obtained initial directions for travelling from the start location to the destination location. As those skilled in the art will appreciate, it is not essential to enter both a start location and a destination location. For example, the user may simply input the desired destination and the web-based navigation server could simply download a map of the area surrounding the destination.

In the first embodiment described above, if the user entered their mobile telephone number into the web-based navigation server, a query was eventually routed to the mobile telephone based navigation control centre. This control centre then transmitted a text message to the user inviting the user to call a given number to receive updated navigation guidance instructions. As those skilled in the art will appreciate, this is not essential. For example, the user may already be familiar with the services provided by the mobile based navigation control centre and the user's details may simply be stored in the mobile control centre so that they are available and can be retrieved when the user calls the control centre. Alternatively still, the mobile telephone based navigation control centre may provide traffic information instead of or in addition to updated route guidance information. For example, after receiving details of a user's travel plans, the mobile telephone based navigation control centre may transmit a text message to the user's mobile telephone advising him that he can obtain traffic information relating to his journey by calling the given number. Further, different telephone numbers may be provided, one for obtaining traffic information and the other for obtaining route guidance information.

In the above embodiments, the web-based navigation server and the mobile telephone based navigation control centre were coupled together through the internet. As those skilled in the art will appreciate, these systems may be coupled together via any data network such as a LAN, WAN, leased line etc.

In the above embodiment, a single mobile telephone-based navigation control centre was provided. As those skilled in the art will appreciate, several navigation control centres may be provided, each operating within a distinct locality of a geographic region. For example, several navigation control centres may be provided in and around large cities (or in different countries), whilst one or two may be provided between the cities in more rural areas. In such an embodiment, the control centres would be arranged to communicate with each other so that as a user enters the geographic area of another navigation control centre, a “handover” procedure can be performed. In this way, the navigation control centres form a distributed network of navigation centres. Further, more than one server may be provided for each geographic locality in order to share the management and processing of navigation queries from different users.

In the above embodiments, the navigation control centre used a road network database and a traffic database to provide driving instructions for the user. As those skilled in the art will appreciate, these databases may be provided by third party systems, with the navigation control system only operating to use the data from those databases.

In the above embodiments, the mobile phone-based navigation control centre calculated the best route from the user's current position to the specified destination. In an alternative embodiment, the navigation control centre may calculate the best route together with one or more alternative routes that the user may take. The system need not inform the user of these alternative routes but could simply store them for use if part of the best route becomes congested. Further, even if the best route doesn't deteriorate, one of the alternative routes might improve sufficiently for it to be worth informing the user. For example, one of the alternative routes might have had a blockage when the original route was being calculated which subsequently cleared and which may offer the user a significant reduction in the journey time. In this case, the system could output to the user the proposed new route.

In the above embodiments, a mobile telephone was used to provide a communication link between the user and the mobile navigation control centre. As those skilled in the art will appreciate, other transmit and receiver systems may be used. However, a cellular telephone is preferred because of its availability.

In the above embodiments, a GPS receiver was provided in the user's mobile telephone for providing current geographical location information of the user. As those skilled in the art will appreciate, other location-based systems may be used to provide this current location information. For example, other satellite navigation systems may be used such as the Russian-based satellite positioning system called Glonass. Alternatively, the mobile telephone or the mobile telephone network can identify the current location of the mobile telephone based on the radio signals within the mobile telephone network. This can be achieved, either by monitoring the signals received by the handset from a number of base stations whose locations are known and/or by monitoring the signal from the handset received by a number of base stations of known location. Either the relative signal strengths or the relative timing of synchronised signals may be measured. In such an embodiment, the GPS receiver may be omitted.

In the above embodiment, a number of processing units of the user's personal computer, the web-based navigation server and the mobile telephone-based navigation control centre have been described. As those skilled in the art will appreciate, the processing units in each of these systems may be dedicated hardware circuits or they may be computer software modules run on a conventional programmable processor. A computer program or programs used to configure such a programmable processor to carry out the processing discussed above may be in the form of source code, object code, a code intermediate source and object code such as a partially compiled form, or in any other form. Such computer programs may be stored in a memory at the time of manufacture of the device or it may be loaded into memory by either downloading the program file from, for example, the internet or from a storage medium such as a CD-ROM or the like.

1. A mobile navigation system comprising:
a first computer system couplable to a data network and comprising:
a prompter operable to prompt for a user mobile telephone number;
a first receiver operable to receive data identifying the mobile telephone number for the user entered in response to said prompt;
a second receiver operable to receive data identifying a desired destination; and
a first transmitter operable to transmit the received telephone number data and the destination data to the data network;
a second computer system couplable to the data network and a telephone network and comprising:
a third receiver operable to receive said telephone number data and said destination data from the data network;
a message data generator operable to generate message data prompting the user to telephone a predetermined telephone number to receive navigation guidance information relating to said destination; and
a second transmitter operable to transmit said message data over said telephone network to the mobile telephone corresponding to the received telephone number data.

2. A system according to claim 1, wherein said message data generator is operable to generate message data comprising a text message for display on a display of the mobile telephone of said user.

3. A system according to claim 1, wherein said prompter is operable to prompt the user to enter their mobile telephone number.

4. A system according to claim 1, wherein said prompter is operable to prompt the user for said destination and wherein said second receiver is operable to receive data identifying said destination from said user.

5. A system according to claim 1, further comprising a user terminal couplable to a data network and comprising:
a connector operable to connect the user terminal to said first computer system and and operable to receive said prompt from said prompter;
a second prompter operable to prompt the user for their mobile telephone number; and
a third transmitter operable to transmit data identifying the input mobile telephone number to said first computer system.

6. A system according to claim 1, wherein said second computer system comprises a fourth receiver operable to receive a telephone call from said user over said telephone network and a provider operable to provide navigation guidance information relating to the destination to the user.

7. A system according to claim 6, wherein said second computer system comprises a determiner operable to determine the current location of the user and a processor operable to process the current location and the desired destination with reference to predetermined road network data to determine route guidance instructions for guiding the user from the determined current location to said destination.

8. A system according to claim 6, wherein said provider is operable to provide said route guidance instructions to said user as voice or text instructions.

9. A system according to claim 1, wherein said first computer system comprises a determiner operable to determine initial route guidance information relating to said destination and a third transmitter operable to transmit said initial route guidance information to said user.

10. A system according to claim 9, wherein said determiner is operable to determine initial route guidance information comprising text instructions or a graphical representation of one or more routes around the desired destination.

11. A system according to claim 9, wherein said first computer system further comprises a fourth receiver operable to receive data identifying an initial location of said user and wherein said determiner is operable to determine said initial route guidance information using said initial location and said desired destination to calculate a route from said initial location to said desired destination.

12. A system according to claim 9, wherein said third transmitter is operable to transmit data relating to the initial route guidance information to said data network and wherein said third receiver is operable to receive said data relating to said initial route guidance information from said data network.

13. A computer system for use in a mobile navigation system comprising:
a prompter operable to prompt for a mobile telephone number of a user;
a first receiver operable to receive data identifying the mobile telephone number of the user entered in response to said prompt;
a second receiver operable to receive data identifying a desired destination; and
a transmitter operable to transmit the received telephone number data and the destination data to a mobile navigation system over the internet.

14. A computer system for use in the system of claim 1, comprising:
a receiver operable to receive telephone number data and destination data from a data network;
a message data generator operable to generate message data prompting a user of the mobile telephone corresponding to said telephone number data to telephone a predetermined telephone number to receive navigation guidance information relating to the destination corresponding to said received destination data; and
a transmitter operable to transmit said message data over the telephone network to the mobile telephone corresponding to the received telephone number data.

15. A mobile navigation system comprising:
a first computer system couplable to a data network and comprising:
a prompter operable to prompt for a user mobile telephone number;
a first receiver operable to receive data identifying the mobile telephone number for the user, entered in response to said prompt;
a second receiver operable to receive data identifying a desired destination; and
a first transmitter operable to transmit the received telephone number data and the destination data to the data network; and
a second computer system couplable to the data network and a telephone network and comprising:
a third receiver operable to receive said telephone number data and said destination data from the data network;
a memory operable to store said received telephone number data and said received destination data;
a third receiver operable to receive a telephone call from said user;
a first determiner operable to determine the telephone number of the telephone being used by the user;
a retriever operable to retrieve destination data corresponding to the determined telephone number from said storing means memory;
a second determiner operable to determine route guidance information relating to said retrieved destination data; and
a second transmitter operable to transmit said route guidance information to said user via said mobile telephone.

16. A navigation method characterised by the use of a system according to claim 1.

17. A mobile navigation system comprising:
a first computer system couplable to a data network and comprising:
means for prompting for a user mobile telephone number;
means for receiving data identifying the mobile telephone number for the user entered in response to said prompt;
means for receiving data identifying a desired destination; and
means for transmitting the received telephone number data and the destination data to the data network;
a second computer system couplable to the data network and a telephone network and comprising:
means for receiving said telephone number data and said destination data from the data network;
means for generating message data prompting the user to telephone a predetermined telephone number to receive navigation guidance information relating to said destination; and
means for transmitting said message data over said telephone network to the mobile telephone corresponding to the received telephone number data.

18. A computer system for use in a mobile navigation system comprising:
means for prompting for the mobile telephone number of a user;
means for receiving data identifying the mobile telephone number of the user entered in response to said prompt;
means for receiving data identifying a desired destination; and
means for transmitting the received telephone number data and the destination data to a mobile navigation system over the internet.

19. A computer system for use in the system of claim 17, comprising:
means for receiving telephone number data and destination data from a data network;
means for generating message data prompting a user of the mobile telephone corresponding to said telephone number data to telephone a predetermined telephone number to receive navigation guidance information relating to the destination corresponding to said received destination data; and
means for transmitting said message data over the telephone network to the mobile telephone corresponding to the received telephone number data.

20. A mobile navigation method comprising:
at a first computer system coupled to a data network:
prompting for a user mobile telephone number;
receiving data identifying the mobile telephone number for the user entered in response to said prompt;
receiving data identifying a desired destination; and
transmitting the received telephone number data and the destination data to the data network;
at a second computer system coupled to the data network and a telephone network:
receiving said telephone number data and said destination data from the data network;
generating message data prompting the user to telephone a predetermined telephone number to receive navigation guidance information relating to said destination; and
transmitting said message data over said telephone network to the mobile telephone corresponding to the received telephone number data.

21. A method according to claim 20, wherein said message data generating step generates message data comprising a text message for display on a display of the mobile telephone of said user.

22. A system according to claim 20, wherein said prompting step prompts the user to enter their mobile telephone number.

23. A system according to claim 20, wherein said prompting step prompts the user for said destination and further comprises receiving data identifying said destination from said user.

24. A system according to claim 20, further comprising, at a user terminal couplable to a data network:
connecting the user terminal to said first computer system and receiving said prompt;
prompting the user for their mobile telephone number; and
transmitting data identifying the input mobile telephone number to said first computer system.

25. A system according to claim 20, wherein at said second computer system, the method further comprises receiving a telephone call from said user over said telephone network and providing navigation guidance information relating to the destination to the user.

26. A system according to claim 25, wherein at said second computer system the method further comprises determining the current location of the user and processing the current location and the desired destination with reference to predetermined road network data to determine route guidance instructions for guiding the user from the determined current location to said destination.

27. A system according to claim 25, further comprising transmitting said route guidance instructions to said user as voice or text instructions.

28. A system according to claim 20, wherein at said first computer system the method further comprises determining initial route guidance information relating to said destination and transmitting said initial route guidance information to said user.

29. A system according to claim 28, wherein said initial route guidance information comprises text instructions or a graphical representation of one or more routes around the desired destination.

30. A system according to claim 28, wherein at said first computer system the method further comprises receiving data identifying an initial location of said user and wherein said determining step determines said initial route guidance information using said initial location and said desired destination to calculate a route from said initial location to said desired destination.

31. A system according to any of claim 28, wherein said transmitting at said first computer system transmits data relating to the initial route guidance information to said data network and wherein said receiving step at said second computer system receives said data relating to said initial route guidance information from said data network.

32. A computer implemented method performed in a mobile navigation system, the method comprising:
prompting for a mobile telephone number of a user;
receiving data identifying the mobile telephone number of the user entered in response to said prompt;
receiving data identifying a desired destination; and
transmitting the received telephone number data and the destination data to a mobile navigation system over the internet.

33. A computer implemented method performed in the system of claim 1, comprising:
receiving telephone number data and destination data from a data network;
generating message data prompting a user of the mobile telephone corresponding to said telephone number data to telephone a predetermined telephone number to receive navigation guidance information relating to the destination corresponding to said received destination data; and
transmitting said message data over the telephone network to the mobile telephone corresponding to the received telephone number data.

34. A mobile navigation method comprising:
at a first computer system coupled to a data network:
prompting for a user mobile telephone number;
receiving data identifying the mobile telephone number for the user, entered in response to said prompt;
receiving data identifying a desired destination; and
transmitting the received telephone number data and the destination data to the data network; and
at a second computer system coupled to the data network and a telephone network:
receiving said telephone number data and said destination data from the data network;
storing said received telephone number data and said received destination data;
receiving a telephone call from said user;
determining the telephone number of the telephone being used by the user;
retrieving the stored destination data corresponding to the determined telephone number;
determining route guidance information relating to said retrieved destination data; and
transmitting said route guidance information to said user via said mobile telephone.

35. A computer readable medium storing computer implementable process steps to configure a programmable computer device to carry out a method comprising:
prompting for a mobile telephone number of a user;
receiving data identifying the mobile telephone number of the user entered in response to said prompt;
receiving data identifying a desired destination; and
transmitting the received telephone number data and the destination data to a mobile navigation system over the internet.

36. A computer readable medium storing computer implementable process steps to configure a programmable computer device to carry out a method comprising:
receiving telephone number data and destination data from a data network;
generating message data prompting a user of the mobile telephone corresponding to said telephone number data to telephone a predetermined telephone number to receive navigation guidance information relating to the destination corresponding to said received destination data; and
transmitting said message data over the telephone network to the mobile telephone corresponding to the received telephone number data.
